(19) United States
(12) Patent Application Publication
(10) Pub. No.: US 2004/0104933 A1
(43) Pub. Date: Jun. 3, 2004

(54) Dynamic role creation

(76) Inventors: Michael Friedrich, Kehl (DE); Sebastian Wagner, Reilingen (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/307,258

(22) Filed: Nov. 29, 2002

(51) Int. Cl. G09G 5/00

(52) U.S. Cl. 345/751

(57) ABSTRACT

Systems and techniques are described to establish a virtual environment. In general, in one implementation, the technique includes receiving information specifying a plurality of participants and a plurality of roles. The received information is presented in a matrix having at least two dimensions including a first dimension corresponding to participants and a second dimension corresponding to roles. An environment creator is enabled to selectively associate a participant with a role by designating an intersection of the first and second dimensions.

### BACKGROUND

The following description relates to methods and techniques for establishing roles in a virtual environment. A virtual environment may be a network-based system, such as an enterprise portal, that permits participants in the environment selective access to resources provided in the environment. The available resources may include documents, files, other structured or unstructured information, and applications or utilities for content creation (e.g., word processing, graphic design), communication (e.g., email, collaboration, video-conferencing) and the like.

As one example, multiple participants may be given access to a virtual environment to facilitate collaboration. The virtual environment enables a group of remote individuals to conduct their collaborative efforts including teaching, learning and working. The virtual room is a metaphor for the emulation of a physical room and objects in the room. Participants invited into the virtual collaboration room may share a common purpose such as negotiation of a contract or projection of future sales. The virtual collaboration room can provide a mechanism for remote participants to coordinate and communicate in an effort to accomplish a task.

Participants may be associated with one or more roles. A “role” is a set of permissions on the services and objects associated with the collaboration room. The services may include, for example, teleconferencing, email, instant messaging and screen sharing systems.

A virtual environment may be set up by a virtual environment owner. The environment owner may associate a role or roles with a participant and provide the services and tools available in the virtual environment.

### SUMMARY

Systems and techniques for establishing a virtual environment are disclosed.

In one aspect, establishing a virtual environment is facilitated by receiving information; specifying a plurality of participants and a plurality of roles; presenting the received information in a matrix having at least two dimensions including a first dimension corresponding to participants and a second dimension corresponding to roles; and enabling a user to selectively associate a participant with a role by designating an intersection of the first and second dimensions.

The first and second dimensions may be rows/columns of the matrix.

The matrix may be displayed as a graphic abstraction including clickable check-boxes at matrix row and column intersections. The associations between participants and croles may be changeable at any time during existence of the virtual environment.

In another aspect, establishing a virtual collaboration environment includes naming the virtual collaboration environment; selecting services available in the collaboration environment; choosing the sequence of the available services and selecting one of the services as a default service; inviting participants to join the virtual collaboration environment; enabling a user to associate a participant with a role by selecting an intersection of a participant and a role in a matrix having the rows and columns identified by roles and participants, respectively; and verifying that the services, participants and roles facilitate collaboration.

Other aspects include an article comprising a machine-readable medium storing machine-readable instructions that, when executed, cause a machine to perform the disclosed techniques, and/or a system that includes one or more computers configured to implement the disclosed techniques.

The systems and techniques described here may provide one or more of the following advantages. In some implementations a participant may be associated with more than one role and/or a role may be associated with more than one participant. Other implementations may have the advantage of limiting the selected association of a participant and a role to the created virtual environment and not affect other virtual environments. The matrix of roles and participants may have the advantage of facilitating a menu-driven method for creation of the virtual environment.

Details of one or more implementations are set forth in the accompanying drawings and the description below. Other features and advantages will be apparent from the description and drawings, and from the claims.

### DESCRIPTION OF DRAWINGS

These and other aspects will now be described in detail with reference to the following drawings.

FIG. 1 is a block diagram of a system that may be used to implement role creation in a virtual environment;

FIG. 2 is a flow chart of an implementation of dynamic role creation in a virtual environment;

FIG. 3 is a flow chart of an implementation of dynamic role creation collaboration room;

FIG. 4 is a flow chart of an implementation of a guided menu method for dynamic collaboration room creation;

FIGS. 5A-5F are illustrative displays associated with the menu method of FIG. 4.

Like reference symbols in the various drawings indicate like elements.

### DETAILED DESCRIPTION

The systems and techniques described here relate to creation roles for participants in a virtual environment. The virtual environment may be, for example, an enterprise portal. The enterprise portal can provide access to content including local, external and networked-based content such as applications and information. Users, also referred to as participants, of the portal may be assigned roles. The enterprise portal uses roles to generate a role-based user interface. The role-based interface may facilitate access to applications and information provided in the enterprise portal. The roles can be used to tailor the content available on the portal, for example, to eliminate superfluous information or limit a particpant's access to specific content. Two participants logging on to the same portal may receive different portal content based on the respective participant's role.

Role templates may be provided to simplify the assignment of roles to participants of the portal. Templates are a set of privileges to content in the portal. The templates may consist of one or more worksets that model a certain task. A workset is a set of activities that belong to one or more related work areas. The templates may be modified to suit a specific purpose. Thus, assigning a role to a participant may enable the portal content available to the participant.

In an implementation, these systems and techniques may be applied to the creation of roles for participants in a collaboration environment. These systems and techniques enable a user, also referred to as a “room owner,” to dynamically create a virtual collaboration environment, which may be referred to as a “collaboration room,” by providing a user interface abstraction, such as an interactive matrix, that allows the room owner to assign roles to participants invited to the collaboration room. The room owner may modify and/or define specific roles for participants. The room owner may also place documents and services in the collaboration room and selectively enable participants to access those documents and services. The user may invite the participants to the collaboration room and specify the roles required to be present before collaboration may begin.

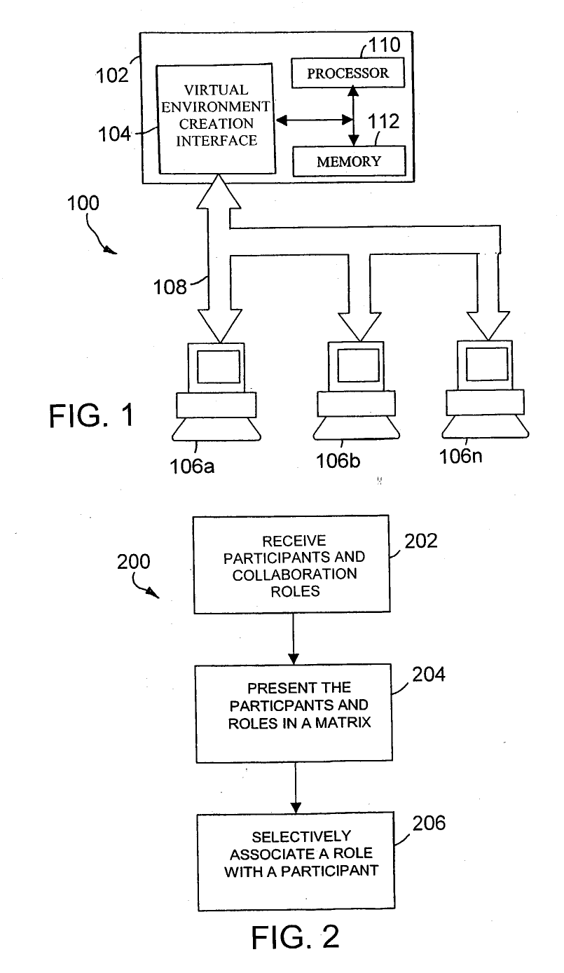

FIG. 1 illustrates a block diagram of a computer system 100 that may be used to implement dynamic role creation in a virtual environment. The system includes a host server 102 including dynamic virtual environment creation software 104 that may accessed by a user using computer devices 106a, 106b, . . . 106n over a network 108.

The dynamic environment creation software 104 may present a user with a virtual environment creation “wizard” that can guide the owner through a series of set-up screens to aide in creation of the virtual environment. The particular guide screens presented by the software may be determined by, for example, the host server using known characteristics of the user's identity. The software 104 also may use techniques other than and in addition to a wizard for creation the virtual environment.

The host server 102 may include, for example, a processor 110 and a memory 112. The memory 112 may be configured to include a database for use by the host server to store and retrieve information related to the operation of the host server including execution of the virtual environment creation software to store the environment set-up parameters and participants with documents and services. The network 108 may include a plurality of devices such as servers, routers and switching elements connected in an intranet, extranet or Internet configuration.

The user, for example, the vitual environment creator, may use a computer device, such as computer 106a, to access the host server 102 over the network 108. The computer device 106a may include a personal computer (PC), personal digital assistant (PDA) or other device using wireless or wired communication protocols to access the host server 102. The computer device 106a may be coupled to I/O devices (not shown) that may include a keyboard in combination with a pointing device such as a mouse to input data into the computer, a computer display screen and/or a printer to produce output from the computer, a storage resource such as a hard disk drive for storing and retrieving data for the computer, and/or other I/O devices.

FIG. 2 is a flow chart 200 of an implementation of dynamic role creation in a virtual environment. A virtual environment may be, for example, a collaboration room where selected participants may work on a common task. Collaborations can be an interaction among two or more individuals and can encompass a variety of behaviors, including communication, information sharing, coordination, cooperation, problem solving, and negotiation. The virtual environment creation software receives 202 the participants and roles for the environment. A “role” is a set of permissions on the services and objects associated with the collaboration room. The services may include, for example, teleconferencing, email, instant messaging and screen sharing systems. The objects may include, for example, documents, databases, applications, data or other information for use by selected collaboration room participants.

The participants and roles are presented 204 in a matrix. The roles and participants may be arranged to identify the columns and rows of the matrix. In one implementation, the roles may identify the columns of the matrix and participants identify the rows of the matrix. In another implementation, the roles may identify the row and the participants identify the columns of the matrix. The rows and columns of the matrix may be orthogonal to one another.

The environment creator selectively 206 associates a participant with a role by designating an intersection in the matrix between the participant and the role. The environment creator may associate a participant with more than one role and/or associate a role with more than one participant. In one implementation, a participant may be associated with a role by clicking with a pointing device such as a mouse, for example, at the desired intersections of the role and participant. In some implementations, the environment creator may change the associative relationships between participants and roles at any time during the existence of the virtual environment. The role assigned to a participant by the environment creator may be valid only in the environment being created. Thus, a participant may be assigned the role of an engineer in one virtual environment while assigned the role of a program manager in a different virtual environment.

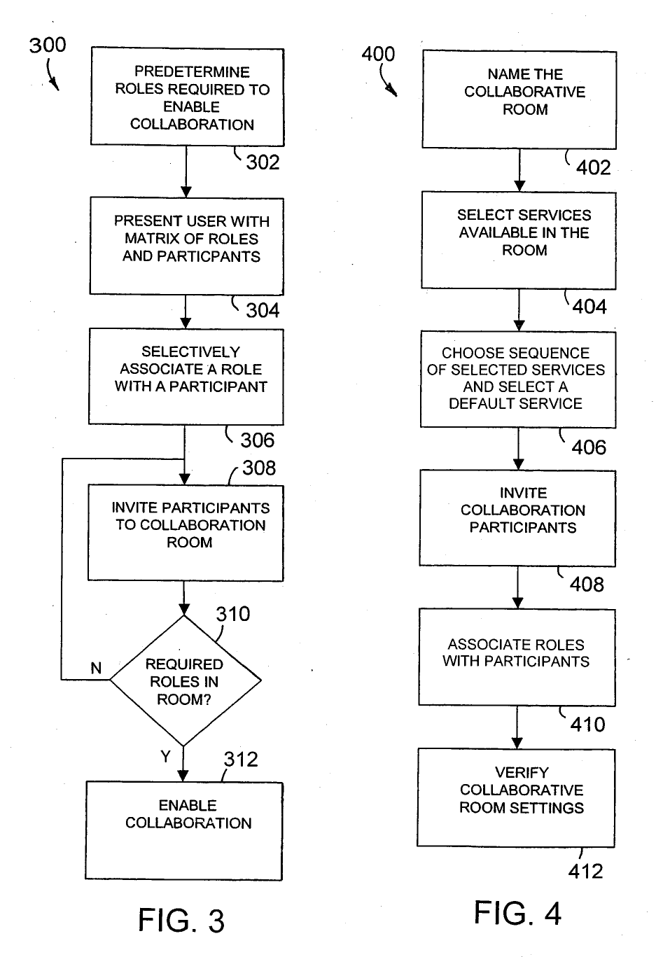

FIG. 3 is a flow chart 300 of implementation of dynamic collaboration role creation in a collaboration room. A collaboration room may be created to accomplish a certain task. Suppose, for example, the task to be accomplished is the negotiation of a supply contract with a vendor. A collaboration room may be set up that requires the participation of participants including a contract administrator, a purchasing agent, an attorney and a sales agent. Others may be invited and collaborate on the solution such as a program manager or an engineer. Documents, such as sample contracts or prior agreements, may be left in the room for use by participants. Services including email, real-time chat or document mark-up, for example, may be provided in the collaboration room.

The environment creator may be referred to, in this example, as the “room owner.” The room owner predetermines 302 the roles desired in the collaboration room to facilitate collaboration among the participants. The participants and roles are presented 304 in a matrix. As described above, the roles and participants may be arranged to identify the columns and rows of the matrix. Also as described above, the room owner selectively 306 associates a participant with a role by designating an intersection in the matrix between the participant and the role. The room owner invites 308 participants to the collaboration room. The room owner may, for example, inhibit collaboration in a room until the predetermined roles are available to facilitate collaboration. As an example, a room owner may inhibit collaboration between participants negotiating a supply contract until a participant having the role of an attorney representing the seller and a participant having the role of an attorney representing the buyer are available for collaboration. If the required roles are not available in the collaboration room 310, the room owner may invite again the participants. Collaboration is enabled 312 when the predetermined roles are available for collaboration.

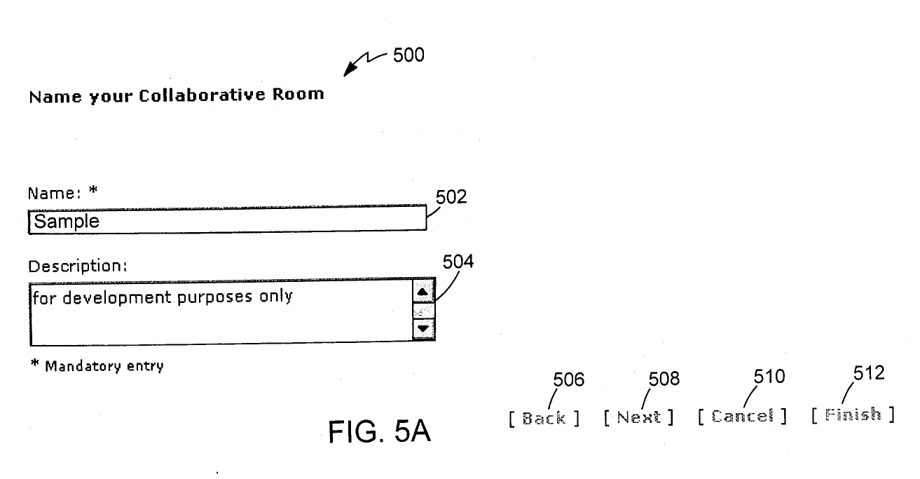

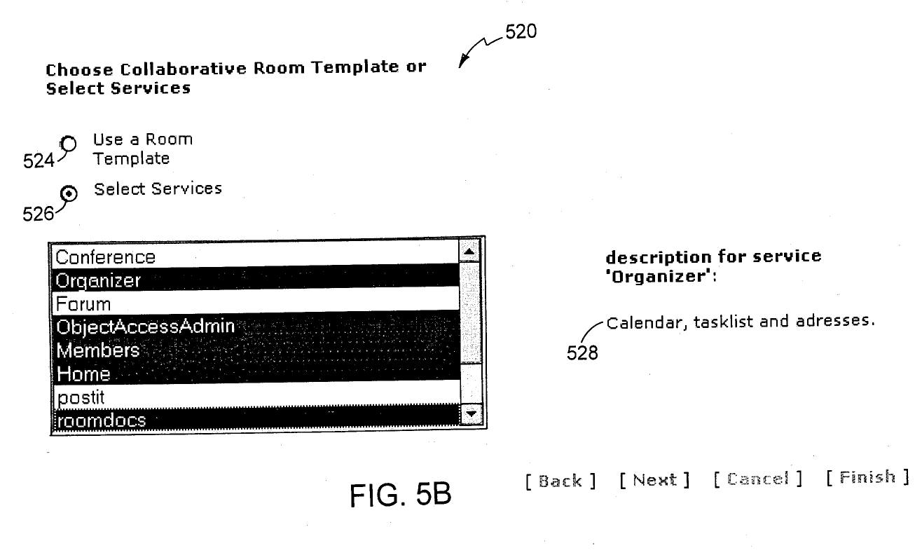

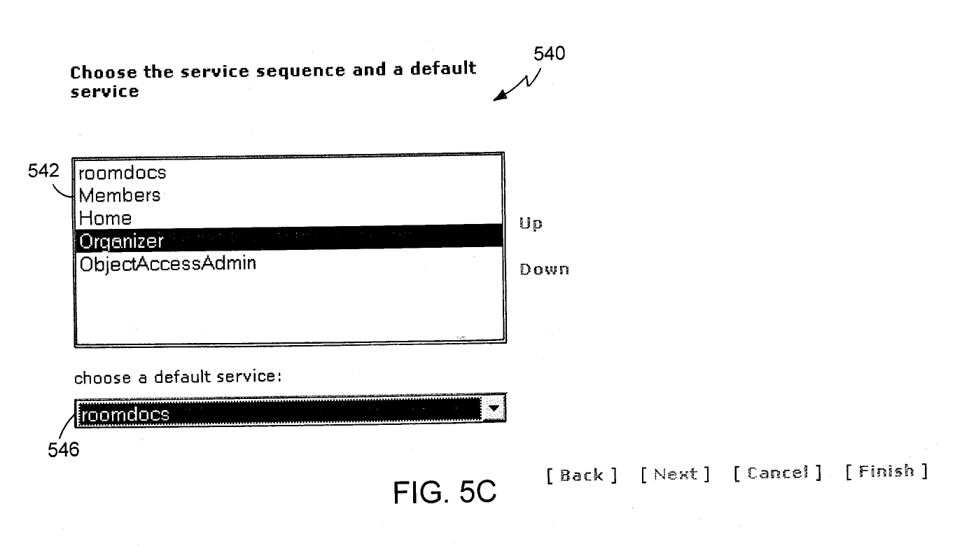

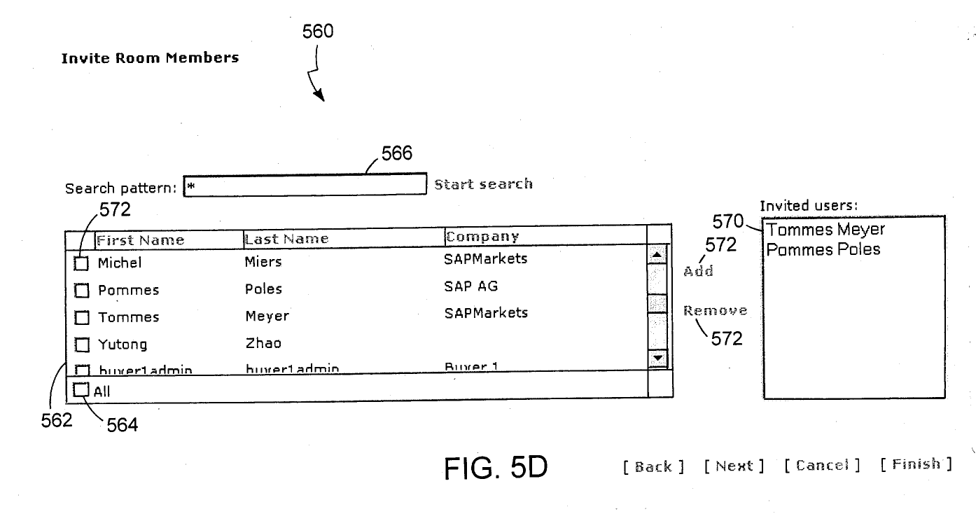

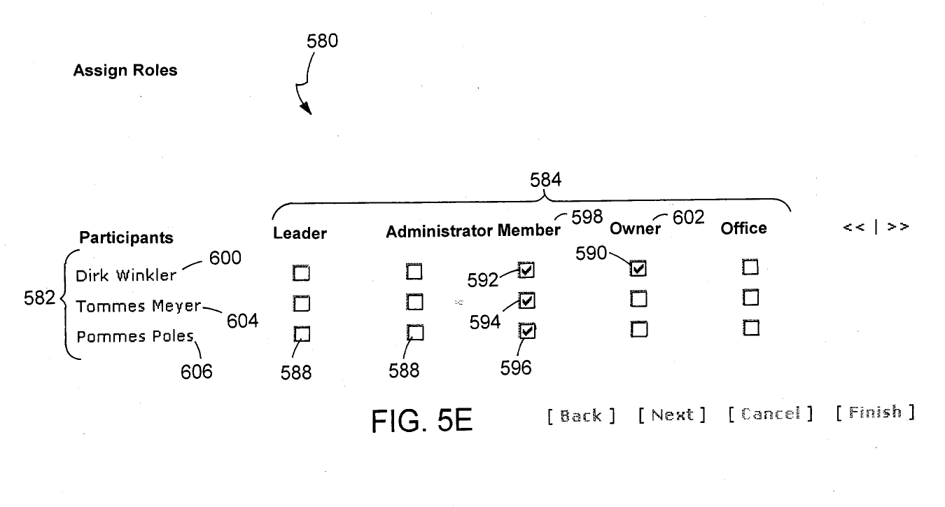

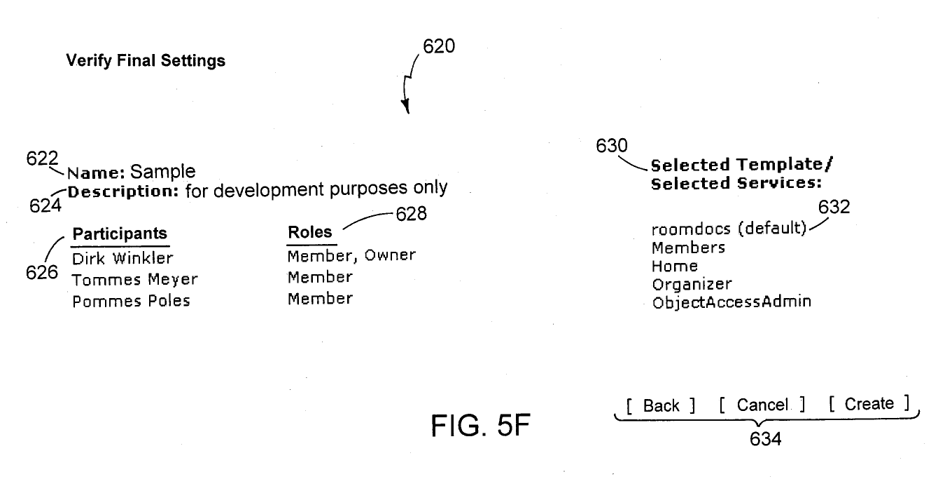

FIG. 4 illustrates a menu-driven method 400 for creation of a collaboration room. FIGS. 5A-5F are displays that may be associated with the menu-driven method of FIG. 4. The menu-driven method can guide the room owner through the creation process of the collaboration room. The room owner provides a name 402 for identification of the collaboration room. FIG. 5A illustrates an implementation of a display 500 for naming the collaboration room. A space 502 is provided in a menu screen for the identification name. The menu screen may also provide for entry of a description 504 that can be an explanation of the purpose of the collaboration room. The name and description may be stored by the dynamic room creation software in a directory that may be viewed by participants and other users. The menu screen may provide navigation buttons including a back button 506 for returning to a previous screen; a next button 508 for proceeding to the next menu screen; a cancel button 510 to delete the entries on the menu and a finish button 512 to complete the menu screen and proceed to the next menu screen.

The room owner then selects 404 services available to participants in the collaboration room. FIG. 5B illustrates an implementation of a display 520 for facilitating selection of services for the collaboration room. The services may be selected from a template 514 of collaboration rooms. A template can provide a predefined structure and content for a collaboration room. The templates may provide standard processes for certain collaboration scenarios including sale opportunity, development project and event organization. The room owner may modify the template services by selecting 516 additional services or deleting existing services to compose the collaboration room according to their requirements. A list of the services selected 518 also may be displayed.

The room owner chooses 406 the service sequence and sets a default service. FIG. 5C illustrates an implementation of a display 540 for facilitating choosing of the service sequence and default service. The services available may be displayed in a service selector 542. The room owner chooses a service sequence. The “service sequence” is the order of display of the services in the service selector 542. The services may be arranged or grouped in any manner that the room owner desires. For example, the room owner may arrange the service sequence so that the more commonly used services appear towards the top of the listing in the services selector. The room owner also may select a default service 546 for the collaboration room. The default service is the service that is active when the room is opened. For example, the room owner may select the most commonly used service to open when the collaboration room is opened. In a collaboration room created for a contract revision, the room owner may select the room documents be opened when the room is opened.

The room owner invites 408 participants to the collaboration room. FIG. 5D illustrates an implementation of a display 560 for inviting selected members to the collaboration room. In one implementation, the display 560 may present a listing 562 of candidate participants. The listing may have information about the candidate participants including their name, company and position. The display may provide for selecting and deselecting particular participants from the listing. For example, a box 572 may be presented near each candidate that may be alternately selected and deselected by clicking on the box with a pointing device such as a mouse. In other implementations, a box 564 may be presented in the listing so that the room owner may select or deselect the entire listing of candidates at one time. A search box 566 may also be presented to facilitate locating particular candidate participants from the listing. The room owner may enter a search pattern in the search box and the room creation software may search the listing using the pattern by any means known to those of ordinary skill in the art. The selected candidates may be added or removed from the invited participants listing 570 by choosing an add/remove selector 572. In some implementations, participants may be added or removed from the invitees to the collaboration room at any time that the collaboration room is in existence.

The room owner associates, or assigns, 410 roles for the invited collaboration participants. FIG. 5E illustrates an implementation of a display 580 for associating invited collaboration participants 582 with collaboration roles 584. The participants 582 and roles 584 are arranged as the rows and columns of a matrix. For example, each participant may identify a unique row of the matrix and each role identify a unique column of the matrix. Selectable boxes 588 may be provided at the intersection of the participants and roles. The room owner may alternatively select and deselect the boxes at the intersections. Selected intersection boxes 590-596 associate a row-identified participant with a column-identified role. A particular participant 600 may be associated with more than one role 598, 602 by selecting more than one intersection box in a row 590, 592. A particular role 598 may be associated with more than one participant 600, 604, 606 by selecting more than one intersection box in a column 592-596. The roles associated with the participants may be effective in the room owner's collaboration room. Hence, participants may have different roles in other collaboration rooms.

The room owner verifies 412 the settings of the collaboration room. FIG. 5F illustrates an implementation of a display 560 that may present the collaboration room settings for verification. The display may include the name 622 and description 624 of the collaboration room. The participants 626 and their associated roles 628 in the collaboration room also may be presented. The selected collaboration room template and/or selected services 630 may be displayed and the default service 632 identified. The room owner may use navigation buttons to return to previous display screens to modify the collaboration room settings, cancel the settings or finish and create the collaboration room using the displayed settings. In some implementations, the room owner may subsequently modify the collaboration room settings as long as the collaboration room is in existence.

The potential implementations and uses of dynamic role creation techniques are not limited to those described above. In general, dynamic role creation such as disclosed here may be used in virtually any situation and/or any environment in which it is desirable to assign roles to individuals or groups of individuals. Such environments include not only enterprise portals and virtual collaboration rooms such as described above, but potentially also in any multi-participant environment such as groupware, online games, training scenarios or other cooperative, competitive or collaborative environments.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Other embodiments are within the scope of the following claims.

What is claimed is:

1. A method of establishing a virtual environment, the method comprising:
receiving information specifying a plurality of participants and a plurality of roles;
presenting the received information in a matrix having at least two dimensions including a first dimension corresponding to participants and a second dimension corresponding to roles; and
enabling a user to selectively associate a participant with a role by designating an intersection of the first and second dimensions.

2. The method of claim 1 wherein the first and second dimensions are rows/columns of the matrix.

3. The method of claim 2 wherein the first and second dimensions are orthogonal to each other.

4. The method of claim 1 comprising displaying the matrix as a graphic abstraction including clickable check-boxes at matrix row and column intersections.

5. The method of claim 1 wherein more than one participant can be associated with a role.

6. The method of claim 1 wherein more than one role can be associated with a participant.

7. The method of claim 1 wherein the associations between participants and roles are changeable at any time during existence of the virtual environment.

8. The method of claim 1 wherein the selected association of a participant and a role is limited to the established virtual collaboration environment.

9. The method of claim 1 wherein each role is associated with a predetermined set of services.

10. The method of claim 1 wherein the virtual environment comprises an enterprise portal.

11. The method of claim 1 wherein the virtual environment comprises a virtual collaboration room.

12. A method of establishing a virtual collaboration environment, the method comprising:
receiving information specifying a plurality of collaboration participants and a plurality of collaboration roles;
presenting the received information in a matrix having at least two dimensions including a first dimension corresponding to collaboration participants and a second dimension corresponding to collaboration roles; and
enabling a user to selectively associate a collaboration participant with a collaboration role by designating an intersection of the first and second dimensions.

13. A method of establishing a virtual collaboration environment, the method comprising:
predetermining a set of roles to facilitate collaboration among participants;
presenting a user with a two-dimensional matrix wherein participants are associated with a first dimension of the matrix and roles are associated with a second dimension of the matrix;
enabling the user to associate a participant with a role by selecting an intersection of a participant and a role in the matrix;
inviting participants to join the virtual collaboration environment; and
enabling collaboration in the virtual collaboration environment when at least each of the predetermined set of roles has been assigned to a participant.

14. The method of claim 13, wherein selecting a role in the matrix comprises marking an intersection of a role and a participant in the matrix.

15. The method of claim 13 wherein the participant's assigned role is limited to the established virtual collaboration environment.

16. The method of claim 13, comprising enabling the user to modify the roles of participants.

17. The method of claim 13 comprising enabling the user to customize roles said customized roles being specific to the virtual collaboration environment.

18. The method of claim 17 wherein the customized role comprises a modification of a predefined role.

19. A method of establishing a virtual collaboration environment, the method comprising:
naming the virtual collaboration environment;
selecting services being available in the collaboration environment;
choosing the sequence of the available services and selecting one of said services as a default service;
inviting participants to join the virtual collaboration environment;
enabling a user to associate a participant with a role by selecting an intersection of a participant and a role in a matrix having the rows and columns identified by roles and participants, respectively; and
verifying that the services, participants and roles facilitate collaboration.

20. An article comprising a machine-readable medium storing machine-executable instructions that, when executed, cause a machine to perform operations comprising:
receive information specifying a plurality of collaboration participants and a plurality of collaboration roles;
present the received information in a matrix having at least two dimensions including a first dimension corresponding to collaboration participants and a second dimension corresponding to collaboration roles; and
enable a user to selectively associate a collaboration participant with a collaboration role by designating an intersection of the first and second dimensions.

21. The article of claim 20 comprising instructions to display the matrix as a graphic abstraction including clickable check-boxes at matrix row and column intersections.

22. The article of claim 20 wherein more than one collaboration participant can be associated with a collaboration role.

23. The article of claim 20 wherein more than one collaboration role can be associated with a collaboration participant.

24. The article of claim 20 wherein the associations between collaboration participants and collaboration roles are changeable at any time during existence of the virtual collaborative environment.

25. The article of claim 20 wherein the selected association of a collaboration participant and a collaboration role is limited to the established virtual collaboration environment.

26. The article of claim 20 wherein each collaborative role is associated with a predetermined set of services.

27. A system for gathering information, the system comprising one or more computers configured to:
receive information specifying a plurality of collaboration participants and a plurality of collaboration roles;
present the received information in a matrix having at least two dimensions including a first dimension corresponding to collaboration participants and a second dimension corresponding to collaboration roles; and
enable a user to selectively associate a collaboration participant with a collaboration role by designating an intersection of the first and second dimensions.

28. The system of claim 25 comprising the computers configured to display the matrix as a graphic abstraction including clickable check-boxes at matrix row and column intersections.

29. The system of claim 27 wherein more than one collaboration participant can be associated with a collaboration role.

30. The system of claim 27 wherein more than one collaboration role can be associated with a collaboration participant.

31. The system of claim 27 wherein the associations between collaboration participants and collaboration roles are changeable at any time during existence of the virtual collaborative environment.

32. The system of claim 27 wherein the selected association of a collaboration participant and a collaboration role is limited to the established virtual collaboration environment.

33. The system of claim 27 wherein each collaborative role is associated with a predetermined set of services.
